(19) United States
(12) Patent Application Publication
(10) Pub. No.: US 2013/0218742 A1
(43) Pub. Date: Aug. 22, 2013

(54) METHOD AND SYSTEM OF PRICING FINANCIAL INSTRUMENTS

(71) Applicant: David Gershon, Tel Aviv (IL)

(72) Inventor: David Gershon, Tel Aviv (IL)

(21) Appl. No.: 13/845,233

(22) Filed: Mar. 18, 2013

Related U.S. Application Data
(63) Continuation of application No. 11/401,466, filed on Apr. 11, 2006, now abandoned.
(60) Provisional application No. 60/669,903, filed on Apr. 11, 2005.

(51) Int. Cl. G06Q 40/04

(52) U.S. Cl. CPC G06Q 40/04
USPC 705/37

(57) ABSTRACT

Some demonstrative embodiments of the invention include a method and/or system of pricing a financial instrument. The method may include receiving trade information of a plurality of traded financial instruments, the trade information including trade information related to a plurality of market prices corresponding to the plurality of traded financial instruments; determining at least one set of market parameter values based on a predefined criterion that relates to a plurality of sets of one or more of the plurality of market prices and to a plurality of sets of one or more model prices that are calculated for the at least one set of market parameter values by a pricing model using the trade information; and estimating a price of the financial instrument using the pricing model based on the at least one set of market parameter values.

### CROSS REFERENCE TO RELATED APPLICATIONS

This application is a Continuation Application of U.S. patent application Ser. No. 11/401,466, filed on Apr. 11, 2006 which, in turn, claims priority from, and the Benefit of, U.S. Provisional Patent Application No. 60/669,903, filed Apr. 11, 2005, the entire disclosures of both of which Applications are incorporated herein by reference.

### FIELD OF THE INVENTION

The invention relates generally to financial instruments and, more specifically, to methods and systems for pricing financial derivatives and/or for providing automatic trading capabilities.

### BACKGROUND OF THE INVENTION

Pricing financial instruments is a complex art requiring substantial expertise and experience. Trading financial instruments, such as options, involves a sophisticated process of pricing typically performed by a trader.

The term “option” in the context of the present application is broadly defined as any financial instrument having option-like properties, e.g., any financial derivative including an option or an option-like component. This category of financial instruments may include any type of option or option-like financial instrument, relating to some underlying asset. Assets as used in this application include anything of value; tangible or non-tangible, financial or non-financial, for example, stocks; commodities, e.g., oil, metals, or sugar; interest rate futures; bond futures; weather, e.g. the temperature at a certain area; credit derivatives; and the like. For example, as used herein, options range from a simple Vanilla option on a single stock and up to complex convertible bonds whose convertibility depends on some key, e.g., the weather.

The term “Exchange” in the context of the present application relates to any one or more exchanges throughout the world, and includes all assets/securities which may be traded in these exchanges. The terms “submit a price to the exchange”, “submit a quote to the exchange”, and the like generally refer to actions that a trader may perform to submit a bid and/or offer prices for trading in the exchange. The price may be transferred from the trader to the exchange, for example, by a broker, by online trading, on a special communication network, through a clearing house system, and/or using in any other desired system and/or method.

The price of an asset for immediate (e.g., 1 or 2 business days) delivery is called the spot price. For an asset sold in an option contract, the strike price is the agreed upon price at which the deal is executed if the option is exercised. For example, a stock option involves buying or selling a stock. The spot price is the current stock price on the exchange in which is the stock is traded. The strike price is the agreed upon price to buy/sell the stock if the option is exercised.

To facilitate trading of options and other financial instruments, a market maker suggests a bid price and offer price (also called ask price) for a certain option. The bid price is the price at which the market maker is willing to purchase the option and the offer price is the price at which the market maker is willing to sell the option. As a market practice, a first trader interested in a certain option may ask second trader for a quote, e.g., without indicating if the first trader is interested to buy or to sell the option. The second trader quotes both the bid and offer prices, not knowing whether the first trader is interested in selling or buying the option. The market maker may earn a margin by buying options at a first price and selling them at a second price, e.g., higher than the first price. The difference between the offer and bid prices is referred to as bid-offer spread.

A call option is the right to buy an asset at a certain price (“the strike”) at a certain time, e.g., on a certain date. A put option is the right to sell an asset at a strike price at a certain time, e.g., on a certain date. Every option has an expiration time in which the option ceases to exist. Prior to the option expiration time, the holder of the option may determine whether or not to exercise the option, depending on the prevailing spot price for the underlying asset. If the spot price at expiration is lower than the strike price, the holder will choose not to exercise the call option and lose only the cost of the option itself. However, if the strike is lower than the spot, the holder of the call option will exercise the right to buy the underlying asset at the strike price making a profit equal to the difference between the spot and the strike prices. The cost of the option is also referred to as the premium.

A forward rate is defined as the predetermined price of an asset at which an agreed upon future transaction will take place. The forward rate may be calculated based on a current rate of the asset, a current interest rate prevailing in the market, expected dividends (for stocks), cost of carry (for commodities), and/or other parameters depending on the underlying asset of the option.

An at-the-money forward option (ATM) is an option whose strike is equal to the forward rate of the asset. In some fields, the at-the-money forward options are generically referred to as at-the-money options, as is the common terminology in the exchanges of currencies, commodities and interest rates options. The at the money equity options are actually the at the money spot, i.e. where the strike is the current spot rate. An in-the-money call option is a call option whose strike is below the forward rate of the underlying asset, and an in the-money put option is a put option whose strike is above the forward rate of the underlying asset. An out-of-the-money call option is a call option whose strike is above the forward rate of the underlying asset, and an out-of-the-money put option is a put option whose strike is below the forward rate of the underlying asset.

An exotic option, in the context of this application, is a generic name referring to any type of option other than a standard Vanilla option. While certain types of exotic options have been extensively and frequently traded over the years, and are still traded today, other types of exotic options had been used in the past but are no longer in use today. Currently, the most common exotic options include “barrier” options, “digital” options, “binary” options, “partial barrier” options (also known as “window” options), “average” options, “compound” options and “quanto” options. Some exotic options can be described as a complex version of the standard (Vanilla) option. For example, barrier options are exotic options where the payoff depends on whether the underlying asset's price reaches a certain level, hereinafter referred to as “trigger”, during a certain period of time. The “pay off” of an option is defined as the cash realized by the holder of the option upon its expiration. There are generally two types of barrier options, namely, a knock-out option and a knock-in option. A knock-out option is an option that terminates if and when the spot reaches the trigger. A knock-in option comes into existence only when the underlying asset's price reaches the trigger. It is noted that the combined effect of a knock-out option with strike K and trigger B and a knock-in option with strike K and trigger B, both having the same expiration, is equivalent to a corresponding Vanilla option with strike K. Thus, knock-in options can be priced by pricing corresponding knock-out and vanilla options. Similarly, a one-touch option can be decomposed into two knock-in call options and two knock-in put options, a double no-touch option can be decomposed into two double knock-out options, and so on. It is appreciated that there are many other types of exotic options known in the art.

Certain types of options, e.g., Vanilla options, are commonly categorized as either European or American. A European option can be exercised only upon its expiration. An American option can be exercised at any time after purchase and before expiration. For example, an American Vanilla option has all the properties of the Vanilla option type described above, with the additional property that the owner can exercise the option at any time up to and including the option's expiration date. As is known in the art, the right to exercise an American option prior to expiration makes American options more expensive than corresponding European options.

Generally in this application, the term “Vanilla” refers to a European style Vanilla option. European Vanilla options are the most commonly traded options; they are traded both on exchanges and over the counter (OTC). American Vanilla options are more popular in the exchanges and, in general, are more difficult to price.

U.S. Pat. No. 5,557,517 (“the '517 patent”) describes a method of pricing American Vanilla options for trading in a certain exchange. This patent describes a method of pricing Call and Put American Vanilla options, where the price of the option depends on a constant margin or commission required by the market maker.

The method of the '517 patent ignores data that may affect the price of the option, except for the current price of the underlying asset and, thus, this method can lead to serious errors, for example, an absurd result of a negative option price. Clearly, this method does not emulate the way American style Vanilla options are priced in real markets.

The Black-Scholes (BS) model (developed in 1973) is a widely accepted method for valuing options. This model calculates a theoretical value (TV) for options based on the probability of the payout, which is commonly used as a starting point for approximating option prices. This model is based on a presumption that the change in the spot price of the asset generally follows a Brownian motion, as is known in the art. Using such Brownian motion model, known also as a stochastic process, one may calculate the theoretical price of any type of financial derivative, either analytically, as is the case for the exotic options discussed above, or numerically. For example, it is common to calculate the theoretical price of complicated financial derivatives through simulation techniques, such as the Monte-Carlo method, introduced by Boyle in 1977. Such techniques may be useful in calculating the theoretical value of an option, provided that a computer being used is sufficiently powerful to handle all the calculations involved. In the simulation method, the computer generates many propagation paths for the underlying asset, starting at the trade time and ending at the time of the option expiry. Each path is discrete and generally follows the Brownian motion probability, but may be generated as densely as necessary by reducing the time lapse between each move of the underlying asset. Thus, if the option is path-dependant, each path is followed and only the paths that satisfy the conditions of the option are taken into account. The end results of each such path are summarized and lead to the theoretical price of the derivative.

The original Black-Scholes model was derived for calculating theoretical prices of European Vanilla options, where the price of the option is described by a relatively simple formula. However, it should be understood that any reference in this application to the Black-Scholes model refers to use of the Black-Scholes model or any other suitable model for evaluating the behavior of the underlying asset, e.g., assuming a stochastic process (Brownian motion), and/or for evaluating the price of any type of option, including exotic options. Furthermore, this application is general and independent of the way in which the theoretical value of the option is obtained. It can be derived analytically, numerically, using any kind of simulation method or any other technique available.

For example, U.S. Pat. No. 6,061,662 (“the '662 patent”) describes a method of evaluating the theoretical price of an option using a Monte-Carlo method based on historical data. The simulation method of the '662 patent uses stochastic historical data with a predetermined distribution function in order to evaluate the theoretical price of options. Examples is the '662 patent are used to illustrate that this method generates results which are very similar to those obtained by applying the Black-Scholes model to Vanilla options. Unfortunately, methods based on historical data alone are not relevant for simulating financial markets, even for the purpose of theoretical valuation. For example, one of the most important parameters used for valuation of options is the volatility of the underlying asset, which is a measure for how the price and/or rate of the underlying asset may fluctuate. It is well known that the financial markets use a predicted, or an expected, value for the volatility of the underlying assets, which often deviates dramatically from the historical data. In market terms, expected volatility is often referred to as “implied volatility”, and is differentiated from “historical volatility”. For example, the implied volatility tends to be much higher than the historical volatility of the underlying asset before a major event, such as risk of war, and in anticipation of or during a financial crisis.

It is appreciated by persons skilled in the art that the Black-Scholes model is a limited approximation that may yield results very far from real market prices and, thus, corrections to the Black-Scholes model must generally be added by traders. For example, In the Foreign Exchange (FX) Vanilla market, and in base metals, the market trades in volatility terms and the translation to option price is performed through use of the Black-Scholes formula. In fact, traders commonly refer to using the Black-Scholes model as “using the wrong volatility with the wrong model to get the right price”.

In order to adjust the BS price, in the Vanilla market, traders use different volatilities for different strikes, i.e., instead of using one volatility per asset per expiration date, a trader may use different volatility values for a given asset depending on the strike price. This adjustment is known as volatility “smile” adjustment. The origin of the term “smile”, in this context, is the typical shape of the volatility vs. strike, which is similar to a flat “U” shape (smile).

The phrase “market price of a derivative” is used herein to distinguish between the single value produced by some known models, such as the Black-Scholes model, and the actual bid and offer prices traded in the real market. For example, in some options, the market bid side may be twice the Black-Scholes model price and the offer side may be three times the Black-Scholes model price.

Many exotic options are characterized by discontinuity of the payout and, therefore, a discontinuity in some of the risk parameters near the trigger(s). This discontinuity prevents an oversimplified model such as the Black-Scholes model from taking into account the difficulty in risk-managing the option. Furthermore, due to the peculiar profile of some exotic options, there may be significant transaction costs associated with re-hedging some of the risk factors. Existing models, such as the Black-Scholes model, completely ignore such risk factors.

Many factors may be taken into account in calculating option prices and corrections. (The term “Factor” is used herein broadly as any quantifiable or computable value relating to the subject option.) Some of the notable factors are defined as follows.

Volatility (“Vol”) is a measure of the fluctuation of the return realized on an asset (e.g., a daily return). An indication of the level of the volatility can be obtained by historical volatility, i.e., the standard deviation of the daily return of the assets for a certain past period.

However, the markets trade based on a volatility that reflects the market expectations of the standard deviation in the future. The volatility reflecting market expectations is called implied volatility. In order to buy/sell volatility one commonly trades Vanilla options. For example, in the foreign exchange market, the implied volatilities of ATM Vanilla options for frequently used option dates and currency pairs are available to users in real-time, e.g., via screens such as REUTERS, Bloomberg or directly from FX option brokers.

Volatility smile, as discussed above, relates to the behavior of the implied volatility with respect to the strike, i.e., the implied volatility as a function of the strike, where the implied volatility for the ATM strike is the given ATM volatility in the market. Typically the plot of the implied volatility as a function of the strike shows a minimum that looks like a smile. For example, for currency options, the minimum tends to be relatively close the ATM strike. In equity options the minimum volatility tends to be significantly below the ATM strike.

Delta is the rate of change in the price of an option in response to changes in the price of the underlying asset; in other words, it is a partial derivative of the option price with respect to the spot. For example, a 25 delta call option is defined as follows: if against buying the option on one unit of the underlying asset, 0.25 units of the underlying asset are sold, then for small changes in the underlying asset price, assuming all other factors are unchanged, the total change in the price of the option and the profit or loss generated by holding 0.25 units of the asset are null.

Vega is the rate of change in the price of an option or other derivative in response to changes in volatility, i.e., the partial derivative of the option price with respect to the volatility.

Volatility Convexity is the second partial derivative of the price with respect to the volatility, i.e. the derivative of the Vega with respect to the volatility, denoted dVega/dVol.

Intrinsic value (IV) for in-the-money knock-out/knock-in exotic options with strike K and trigger (or barrier) B, is defined as IV=|B−K|/B. Sometimes in-the-money knockout/knock-in options are also referred to as Reverse knock-out/knock-in options, respectively. For a call option, the intrinsic value is the greater of the excess of zero and the asset spot price over the strike price divided by the spot price. In other words, the intrinsic value of in-the money knock out options is the intrinsic value of a corresponding Vanilla at the barrier, and represents the level of payout discontinuity in the vicinity of the trigger.

Risk Reversal (RR) is the difference between the implied volatility of a call option and a put option with the same delta (in opposite directions). Traders in the currency options market generally use 25delta RR, which is the difference between the implied volatility of a 25delta call option and a 25delta put option. Thus, 25delta RR may be calculated as follows:

25delta RR=implied Vol (25delta call)−implied Vol (25delta put)

The 25delta RR may correspond to a combination of buying a 25 delta call option and selling a 25 delta put option. Accordingly, the 25delta RR may be characterized by a slope of Vega of such combination with respect to spot. Thus, the price of the 25delta RR may characterize the price of the Vega slope, since practically the convexity of 25delta RR at the current spot is zero. Therefore, the 25delta RR as defined above may be used to price the slope dVega/dspot.

The strangle price can be presented as the average of the implied volatility of the call with strike above the ATM and the put with strike below the ATM strike, which usually have the same delta. For example:

25delta strangle=0.5 (implied Vol (25delta call)+implied Vol (25delta put))

The 25delta strangle may be characterized by practically no slope of Vega with respect to spot at the current spot, but a lot of convexity (i.e., a change of Vega when the volatility changes). Therefore it is used to price convexity.

Since the at-the-money Vol may be always known, it is more common to quote the butterfly in which one buys one unit of the strangle and sells 2 units of the ATM 25 option. In some assets, e.g., currencies, the strangle/butterfly is quoted in terms of volatility. For example:

25delta butterfly=0.5*(implied Vol (25delta call)+implied Vol (25delta put))−ATM Vol

The reason it is more common to quote the butterfly rather than the strangles is that butterfly provides a strategy with almost no Vega but significant convexity. Since butterfly and strangle are related through the ATM volatility, which is always known, they may be used interchangeably. The 25delta put and the 25delta call can be determined based on the 25delta RR and the 25delta strangle. The ATM volatility, 25 delta risk reversal and/or the 25 delta butterfly may be referred to, for example, as the “Volatility Parameters”. The Volatility Parameters may include any additional and/or alternative parameters and/or factors.

Gearing, also referred to as leverage, is the difference in price between the exotic option with the barrier and a corresponding Vanilla option having the same strike. It should be noted that a Vanilla option is always more expensive than a corresponding exotic option.

Bid/offer spread is the difference between the bid price and the offer price of a financial derivative. In the case of options, the bid/offer spread may be expressed, for example, either in terms of volatility or in terms of the price of the option. For example, the bid/ask spread of exchange traded options is quoted in price terms (e.g., cents, etc). The bid/offer spread of a given option depends on the specific parameters of the option. In general, the more difficult it is to manage the risk of an option, the wider is the bid/offer spread for that option.

In order to quote a price, traders typically try to calculate the price at which they would like to buy an option (i.e., the bid side) and the price at which they would like to sell the option (i.e., the offer side). Many traders have no computational methods for calculating the bid and offer prices, and so traders typically rely on intuition, experiments involving changing the factors of an option to see how they affect the market price, and past experience, which is considered to be the most important tool of traders.

One dilemma commonly faced by traders is how wide the bid/offer spread should be. Providing too wide a spread reduces the ability to compete in the options market and is considered unprofessional, yet too narrow a spread may result in losses to the trader. In determining what prices to provide, traders need to ensure that the bid/offer spread is appropriate. This is part of the pricing process, i.e., after the trader decides where to place the bid and offer prices, he/she needs to consider whether the resultant spread is appropriate. If the spread is not appropriate, the trader needs to change either or both of the bid and offer prices in order to show the appropriate spread.

Option prices that are quoted in exchanges typically have a relatively wide spread compared to their bid/ask spread in the OTC market, where traders of banks typically trade with each other through brokers. In addition the exchange price typically corresponds to small notional amounts of options (lots). A trader may sometimes change the exchange price of an option by suggesting a bid price or an offer price with a relatively small amount of options. This may result in the exchange prices being distorted in a biased way.

In contrast to the exchanges, the OTC market has a bigger “depth” in terms of liquidity. Furthermore, the options traded in the OTC market are not restricted to specific strikes and expiration dates of the options traded in the exchanges. In addition, there are many market makers that do not support the prices quoted in the exchanges. Such market makers may show prices that are different than the exchange prices.

One of the reasons that exchange prices of options are quoted with a wide spread is that the prices of options corresponding to many different strikes, and many different dates may change very frequently, e.g., in response to each change in the price of the underlying assets. As a result the people that provide the bid and ask prices to the exchange have to constantly update a large number of bid and ask prices simultaneously, e.g., each time the price of the underlying assets changes. In order to avoid this tedious activity, it is mostly preferred to use “safe” bid and ask prices, which will not need to be frequently updated.

### SUMMARY OF SOME DEMONSTRATIVE EMBODIMENTS OF THE INVENTION

Some demonstrative embodiments of the invention include a method and/or system of pricing financial instruments, e.g., financial derivatives.

According to some demonstrative embodiments of the invention, a method of pricing a financial instrument relating to an underlying asset may include receiving trade information of a plurality of traded financial instruments related to the underlying asset, the trade information including trade information related to a plurality of market prices corresponding to the plurality of traded financial instruments; determining at least one set of market parameter values based on a predefined criterion that relates to a plurality of sets of one or more of the plurality of market prices and to a plurality of sets of one or more model prices that are calculated for the at least one set of market parameter values by a pricing model using the trade information; and/or estimating a price of the financial instrument using the pricing model based on the at least one set of market parameter values.

According to some demonstrative embodiments of the invention, estimating the price of the financial instrument may include determining a set of estimated parameter values corresponding to the financial instrument based on the at least one set of market parameter values; and estimating the price of the financial instrument using the pricing model based on the set of estimated values.

According to some demonstrative embodiments of the invention, determining the set of market parameter values based on the predefined criterion may include determining the set of market parameter values based on a plurality of difference values corresponding to the plurality of sets of market prices and to the plurality of sets of model prices.

According to some demonstrative embodiments of the invention, determining the set of market parameter values may include minimizing a weighted combination of the plurality of difference values. For example, the method may include assigning a plurality of weights to the plurality of difference values, respectively. The method may include, for example, determining at least one of the weights based on a relation between one or more market prices of a set of the sets of market prices and a market price of the underlying asset.

According to some demonstrative embodiments of the invention, the plurality of sets of market prices may include, for example, a plurality of sets of market prices corresponding to a plurality of strike prices, respectively. The plurality of sets of model prices may include, for example, a plurality of sets of model prices corresponding to the plurality of strike prices, respectively.

According to some demonstrative embodiments of the invention, the at least one set of market parameter values may include, for example, a plurality of sets of market parameter values corresponding to a plurality of expiration dates, respectively. Receiving the trade information may include, for example, receiving trade information of traded financial instruments corresponding to the plurality of expiration dates.

According to some demonstrative embodiments of the invention, the financial instrument may include a financial derivative. For example, the financial derivative may include an option. The financial derivative may have, for example, a predefined strike price and/or a predefined expiration date.

According to some demonstrative embodiments of the invention, the trade information related to the plurality of market prices may include trade information expressed in terms of volatility.

According to some demonstrative embodiments of the invention, the underlying asset may include, for example, a stock, a bond, a commodity, an interest rate, and the like.

According to some demonstrative embodiments of the invention, the plurality of market prices may include, for example, a bid price, an offer price, a last traded price, a bid/offer spread, and the like.

According to some demonstrative embodiments of the invention, the set of market parameter values may include values of one or more of a volatility, an at-the-money volatility, a risk-reversal, a butterfly, and a strangle.

According to some demonstrative embodiments of the invention, the method may also include, for example, determining a value of a predefined rate relating to the underlying asset based on the trade information. The rate may include, for example, a dividend rate and/or a commodity carry rate.

According to some demonstrative embodiments of the invention, receiving the trade information may include receiving the trade information from an exchange. The method may include, for example, broadcasting to the exchange a bid price and/or an offer price based on the estimated price of the financial instrument.

According to some demonstrative embodiments of the invention, the method may include estimating a plurality of prices of a plurality of selected financial instruments, respectively, using the pricing model based on the at least one set of market parameter values.

According to some demonstrative embodiments of the invention, the plurality of financial instruments may include the financial instrument.

According to some demonstrative embodiments of the invention, a system of pricing a financial instrument relating to an underlying asset, may include a server to receive trade information of a plurality of traded financial instruments related to the underlying asset, the trade information including trade information related to a plurality of market prices corresponding to the plurality of traded financial instruments, and to provide an output corresponding to an estimated price of the financial instrument; and a processor, associated with the server, to compute at least one set of market parameter values based on a predefined criterion that relates to a plurality of sets of one or more of the plurality of market prices and to a plurality of sets of one or more model prices that are calculated for the at least one set of market parameter values by a pricing model using the trade information, and to compute the estimated price of the financial instrument using the pricing model based on the at least one set of market parameter values.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a flow chart of a method of pricing a financial instrument according to some demonstrative embodiments of the invention;

FIG. 2 is a schematic illustration of a flow chart of a method of determining one or more market volatility parameters in accordance with some demonstrative embodiments of the invention;

FIG. 3 is a schematic illustration of a method of determining one or more estimated data parameters according to some demonstrative embodiments of the invention;

FIG. 4 is a schematic illustration of a system of pricing financial instruments in accordance with some demonstrative embodiments of the invention;

FIG. 5 is a graph depicting exchange bid prices, exchange ask prices, exchange mid prices, and determined mid prices, respectively, versus strike prices of an option, in accordance with a first demonstrative embodiment of the invention;

FIG. 6 is a graph depicting exchange bid prices, exchange ask prices, exchange mid prices, and determined mid prices, respectively, versus strike prices of an option, in accordance with a second demonstrative embodiment of the invention; and

FIG. 7 is a graph depicting exchange bid prices, exchange ask prices, exchange mid prices, and determined mid prices, respectively, versus strike prices of an option, in accordance with a third demonstrative embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses and/or systems for performing the operations herein. These apparatuses/systems may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Some demonstrative embodiments of the present invention are described herein in the context of a model for calculating a Market Price (MP), i.e., the market value, of financial instrument, e.g., a stock option. It should be appreciated, however, that models in accordance with the invention may be applied to other financial instruments and/or markets, and the invention is not limited to stock options. One skilled in the art may apply the present invention to other options and/or option-like financial instruments, e.g., options on interest rate futures, options on commodities, and/or options on non-asset instruments, such as options on the weather, and the like, with variation as may be necessary to adapt for factors unique to a given financial instrument.

Some demonstrative embodiments of the invention include a method and/or a system of pricing a defined option, e.g., a vanilla option on a stock having a predetermined strike price, K, and a predetermined expiration date, T, based on trade information corresponding to one or more traded options, as described below.

According to some demonstrative embodiments of the invention, a predetermined pricing model may be used to determine a price, denoted P(K, T), of an option. The pricing model may be based on one or more model parameters, e.g., volatility parameters and/or any one or more desired parameters, which may be determined based on the information corresponding to the one or more traded options, as described below.

According to some demonstrative embodiments of the invention, the information corresponding to the one or more traded options may include, for example, a plurality of exchange prices, denoted PEx(Ki, Tj), relating, for example, to a plurality of bid and/or ask prices corresponding to a plurality of strike prices, denoted Ki, and a plurality expiration dates, denoted Tj, respectively.

According to some demonstrative embodiments of the invention, the information corresponding to the traded options may be used for determining one or more of the model parameters based on a predefined criterion. For example, a plurality of model prices, denoted P(Ki, Tj), may be determined corresponding to the traded options and one or more of the model parameters. One or more of the model parameters may be determined such that a difference between the exchange prices PEx(Ki,Tⱼ), and the model prices P(Ki,Tⱼ) is relatively reduced, e.g., minimized, as described in detail below. The pricing model may then be used, e.g., with one or more of the determined model parameters, for pricing any one or more desired options, as described in detail below.

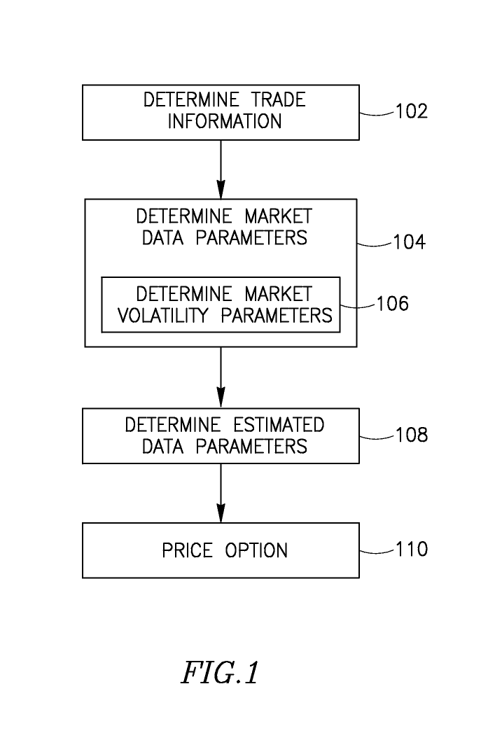

Reference is made to FIG. 1, which schematically illustrates a flow chart of a method of pricing financial instruments, e.g., a defined option, according to some demonstrative embodiments of the invention.

As indicated at block 102, the method may include receiving trade information corresponding to one or more traded options. The trade information may be based, for example, on assets that are continuously traded in the market and their prices may be received in different forms. For example, the trade information may be received from screens of market data provided by companies such as REUTERS, Bloomberg, Telerate, and the like; from exchanges either directly or indirectly, e.g., through a third party vendor; and/or directly from brokers, e.g., over the telephone or the Internet.

According to some demonstrative embodiments of the invention, the trade information may include, for example, Over-The-Counter (OTC) trade information and/or exchange information corresponding to one or more traded options, e.g., one or more traded options having the same underlying asset as the defined option. The trade information may correspond, for example, to a series of strike prices, denoted Kᵢ, wherein i=1 . . . n; and to a series of expiration dates, denoted Tⱼ, wherein j=1 . . . m. The trade information may include, for example, a bid price, denoted Pbid; and/or an ask price, denoted Pask, for each option having an expiration date Tⱼ, and a strike price Kᵢ. The trade information may also include a price, denoted S, of the underlying asset (“the spot price”) and/or one or more future prices, denoted F(Tⱼ), of the underlying asset at date Tⱼ, respectively. The trade information may additionally or alternatively include any other desired information related to the traded options.

As indicated at block 104, the method may include according to some demonstrative embodiments of the invention, determining one or more market data parameters corresponding to one or more of the expiration dates Tⱼ, e.g., based on a predefined criterion, as described in detail below.

As indicated at block 106, determining the market data parameters may include determining, based on the predefined criterion, one or more market volatility parameters corresponding to one or more of the expiration dates Tⱼ. The market volatility parameters may be determined using a method of pricing financial derivatives based on the trade information, as described below.

Some demonstrative embodiments of the invention, e.g., as described herein, may relate to pricing an option using a pricing model, which may be based on one or more volatility parameters. However, it will be appreciated by those skilled in the art, that according to other embodiments of the invention any other desired pricing model may be used, e.g., a pricing model based, additionally or alternatively, on any other suitable parameters. For example, the pricing model may be based on a polynomial, e.g., a parabola, having a predefined number of N coefficients, which may be fitted, for example, to the volatility of the Black-Scholes model.

Certain aspects of methods and/or systems for pricing financial derivatives, e.g., traded options, in accordance with demonstrative embodiments of the invention, are described in International Application PCT/IB01/01941, filed Oct. 13, 2001, entitled “METHOD AND SYSTEM FOR PRICING FINANCIAL DERIVATIVES” and published 24 Apr. 2003 as PCT Publication WO 03/034297 (“Reference 1”), the disclosure of which is incorporated herein by reference. Some demonstrative aspects of Reference 1 describe a pricing model for determining a MP, a market bid price (MPbid), a market ask price (MPask), and/or a MP bid/offer spread (MPspread) of a traded financial derivative based on trade information corresponding to the traded financial derivative, and/or market data parameters. The MP, Mpbid, Mpask and MPspread of an option may be related, for example, as follows:

MP=(MPbid+MPask)/2 (1)

MPspread=MPask−MPbid (2)

For example, a pricing model, e.g., as described in Reference 1, may be implemented for determining the MP, MPask, MPbid, and/or MPspread of an option. The MP, MPask, MPbid, and/or MPspread of an option may be determined, e.g., depending on the underlying asset, based on the interest rate, denoted r, of a currency which may be used to quote the value of the underlying asset (e.g. if a price of a stock is quoted in US Dollars, then the interest rates prevailing for deposit until the expiration date Tⱼ in the United States of America may be used); a dividend rate, denoted D(Tⱼ), corresponding to expiration date e.g., if the underlying asset is a stock, or a carry rate, denoted C(Tⱼ), corresponding to a storage cost rate for the period until the expiration date Tⱼ, e.g., if the underlying asset is a commodity; the at-the-money (ATM) volatility for the expiration date of the option; and/or one or more market volatility parameters corresponding to the expiration date of the option, e.g., the 25delta RR and/or the 25delta butterfly volatility parameters. It will be appreciated by those skilled in the art, that although some demonstrative embodiments of the invention are described herein as using the 25delta RR and/or the 25delta butterfly volatility parameters, other embodiments may relate to using, additionally or alternatively, one or more other parameters, for example, one or more other market volatility parameters, e.g., any suitable RR parameter, any suitable butterfly parameter and/or a combination of market volatility for two or more strikes. Any other additional and/or alternative parameters may bay used, e.g., in accordance with one or more parameters used by the pricing model. For example, the methods and/or systems of Reference 1 may be implemented to determine the 25delta RR and/or 25delta butterfly volatility parameters that will produce a given price difference between two strikes and a given price summation of two strikes.

Some demonstrative embodiments of the invention as described herein may relate to determining one or more of the market data parameters using pricing model for pricing financial derivatives, e.g., as described in Reference 1. However, it will be appreciated by those skilled in the art, that other embodiments of the invention, may implement any other suitable pricing model, method and/or system, additionally or alternatively, to determine one or more of the market data parameters.

As indicated at block 108, the method may include determining one or more estimated data parameters corresponding to the defined option, based on one or more of the determined market data parameters, as described in detail below. The estimated data parameters may include, for example, one or more estimated volatility parameters, e.g., the estimated ATM, the estimated 25delta RR and/or the estimated 25delta butterfly, corresponding to the expiration date T of the defined option.

As indicated at block 110, the method may include pricing the defined option based on one or more of the estimated data parameters, for example, using the pricing model described in Reference 1.

Some demonstrative embodiments of the invention may relate to trade information, which may include, for example, strike prices of traded options. However, according to other embodiments of the invention, the trade information may include any additional or alternative type of information, e.g., spread prices of the options. One or more of the parameters of the pricing model may be estimated using any desired method, e.g., in accordance with the type of the trade information. For example, the trade information may include market prices corresponding to three or more strikes and the same expiration date. Accordingly, a pricing model, e.g., as described by Reference 1, may be used to determine one or more estimated volatility parameters, e.g., the ATM volatility, the 25delta RR, the 25delta butterfly, any other delta RR parameter, and/or any other delta butterfly parameter. The pricing model may then be used, based on the determined volatility parameters, to price one or more options having, for example, expirations, which are generally close to the three or more strikes.

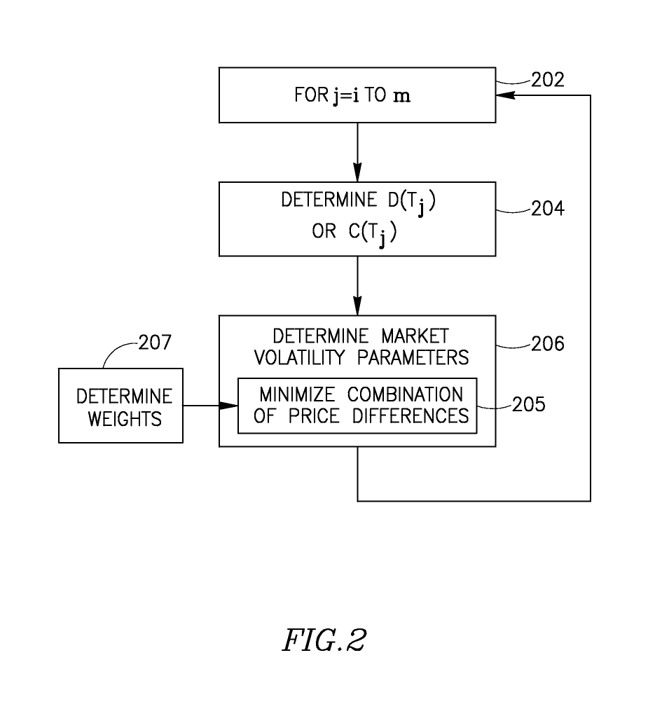

Reference is made to FIG. 2, which schematically illustrates a flow chart of a method of determining, based on predetermined criteria, one or more parameters, e.g., market volatility parameters corresponding to one or more predetermined expiration dates, in accordance with some demonstrative embodiments of the invention. Although the invention is not limited in this respect, one or more operations of the method of FIG. 2 may be implemented to determine one or more market volatility parameters corresponding to one or more of the expiration dates T_{J}, as described above with reference to block 106 of FIG. 1.

As indicated at block 204, the method may include determining, based on the trade information, a rate related to the underlying asset; for example, the dividend rate D(Tⱼ), e.g., if the underlying asset is a stock, or the carry rate C(Tⱼ), e.g., if the underlying asset is a commodity.

According to some demonstrative embodiments of the invention, the dividend rate D(Tⱼ) may be determined based on a future price, of the asset F(Tⱼ), e.g., using the following equation:

F(T_{J})=S*(1+r*Tⱼ/360)*exp(−Tⱼ*D(Tⱼ)/365) (3)

In analogy, the commodity carry rate C(Tⱼ) may be determined based on a future price, of the asset F(Tⱼ), e.g., using the following equation:

F(T_{J})=S*(1+r*Tⱼ/360)*exp(−Tⱼ*C(Tⱼ)/365) (4)

According to some demonstrative embodiments of the invention, the trade information may include the future price F(Tⱼ). According to these embodiments, the dividend rate D(Tⱼ) and/or the carry rate C(Tⱼ) may be directly determined, e.g., using Equations 3 and/or 4, respectively. According to other embodiments of the invention, the dividend and/or carry rates may be determined based on any other information, and/or using any suitable estimation method, e.g., as described below. According to some demonstrative embodiments of the invention, it may not be required to determine the rate relating to the underlying asset, for example, if one or more values representing the rate, e.g., the dividend rate or the carry rate, are received as part of the trade information.

According to other demonstrative embodiments of the invention, the trade information may not include one or more of the future prices corresponding to one or more of the expiration dates. According to these embodiments, it may be desired to determine the value of F(Tⱼ) based on one or more values of the trade information, e.g., as described below.

According to demonstrative embodiments of the invention, trade information of two options having two strike prices, denoted Kₐ and K_{b}, may be used to determine the future price F(Tⱼ). The strike prices Kₐ and K_{b} may be selected, for example, corresponding to options having the relatively highest degree of market liquidity, since the prices of such options may be presumed to be relatively accurate. Thus, for example, the strike prices Kₐ and K_{b} may be selected as the two consecutive strike prices closest to the spot price S, e.g., Kₐ≦S and K_{b}>S.

Buying a Call option and selling a Put option having the same strike price and expiry date may be analogous to a forward agreement for buying the underlying asset at the same strike price and the expiration date. Thus a forward rate, F(Tⱼ)₁, corresponding to the option having the strike price Kₐ, and/or a forward rate, F(Tⱼ)₂, corresponding to the option having the strike price K_{b} may be determined, for example, using the following equations:

0.5*(PbidCALL(Kₐ)+PaskCALL(Kₐ)−(PbidPUT(Kₐ)+PaskPUT(Kₐ))==(F(Tⱼ)₁−Kₐ)/(1+r*Tⱼ/360) (⁵)

0.5*(PbidCALL (K_{b})+PaskCALL(K_{b})−(PbidPUT (K_{b})+PaskPUT(K_{b}))==(F(T)₂−K_{b})/(1+r*T1360) (6)

wherein PbidCALL(Kₐ) denotes a bid price for a call option having the strike price Kₐ; PaskCALL(Kₐ) denotes an ask price for a call option having the strike price Kₐ; PbidPUT(Kₐ) denotes a bid price for a put option having the strike price Kₐ; PaskPUT(Kₐ) denotes an ask price for a put option having the strike price Kₐ; PbidCALL(K_{b}) denotes a bid price for a call option having the strike price K_{b}; PaskCALL(K_{b}) denotes an ask price for a call option having the strike price K_{b}; PbidPUT(K_{b}) denotes a bid price for a put option having the strike price K_{b}; and PaskPUT(K_{b}) denotes an ask price for a put option having the strike price K_{b}.

According to some demonstrative embodiments of the invention, the future price F(Tⱼ) may be estimated based on a function of forward rates F(Tⱼ)₁ and F(Tⱼ)₂, for example, a weighted average or a simple average, e.g., according to the following equation:

F(T)=0.5*(F(Tⱼ)₁+F(T)₂) (⁷)

Thus, the dividend rate D(T) and/or the carry rate C(T) may be determined by estimating F(Tⱼ), e.g., using Equations 5, 6 and 7; substituting the estimated F(Tⱼ) into Equations 3 and/or 4; and solving for D(Tⱼ) and/or C(Tⱼ).

According to other embodiments of the invention, the future price and/or the carry rate may be determined based on any other desired number of strikes. For example, the future price and/or the carry rate may be determined based on only on strike, e.g., kₐ. Alternatively, the future price and/or the carry rate may be determined based on more than two strikes, e.g., by determining an average of future prices and/or carry rates corresponding to a plurality of strikes.

Any other suitable method may be used for determining the future rate, the carry rate and/or the dividend rate. For example, according to some embodiments of the invention, the parameters of the pricing module may also include the future price, the carry rate, and/or the dividend rate. Accordingly, the future price, the carry rate, and/or the dividend rate may be determined based on the trade information, for example, in analogy to the manner other parameters, e.g., the volatility parameters, may be determined and/or simultaneously obtained, such that prices of options corresponding to the determined parameters are relatively close to the trade prices of the options, e.g., as described herein.

As indicated at block 206, the method may also include determining, based on the predefined criterion, one or more market volatility parameters corresponding to the expiration date Tⱼ.

According to some demonstrative embodiments of the invention, determining the market volatility parameters may include defining a series of price differences, denoted X_{q}, of l respective strike prices K_{q} of the expiration date Tⱼ, wherein q=1 . . . , and wherein the price difference X_{q} is defined as the difference between the MP value, which may be determined by the pricing model, e.g., the pricing model described in Reference 1, using a set of volatility parameters corresponding to the expiration date and the exchange prices of the traded options having the strike price K_{q}. For example, X_{q} may be defined by the following equation:

X_{q}=(MPbid(K_{q})+MPask(K_{q}−Pbid(K_{q})−Pask(K_{q})) (8)

According to some demonstrative embodiments of the invention, determining a MP corresponding to expiration date Tⱼ, e.g., using the pricing model of Reference 1, may include determining a bid/offer spread, MPspread(Tⱼ), corresponding to the expiration date Tⱼ. The value of ATMspread(Tⱼ) may be determined using any suitable criteria. For example, ATMspread(Tⱼ) may be determined as a combination or other function, e.g., an average, of the bid-ask-spread of two or more strike prices, e.g., the strike prices closest to the spot price S. Alternatively, the value ATMspread(Tⱼ) may be preset according to the liquidity of the option, e.g., 3% volatility for low-liquidity options, 2% volatility for medium-liquidity options, and 1% volatility for high-liquidity options. The liquidity of the options may be determined, for example, based on an average daily volume of the options, e.g., during a period of three months. Alternatively, the value ATMspread(Tⱼ) may be determined in relation to the bid-ask spread of the spot price S of the underlying asset, or using any other suitable criteria. For example, the ATMspread(Tⱼ) may be determined based on a typical bid/ask spread, e.g., a bid/ask spread typically quoted in the OTC market.

As indicated at block 205, according to some demonstrative embodiments of the invention, determining the one or more market volatility parameters may include minimizing a combination of the l price differences X_{q}, as described below.

Some traded options may have a relatively high liquidity and accordingly, the exchange price of such options may be relatively accurate, whereas other traded options may have a relatively low liquidity and accordingly, the exchange price of these options may be relatively in-accurate. For example, an option having a strike price, which may be relatively very far from the spot price of the underlying asset, may have an exchange bid price equal to zero and a relatively high and in-accurate exchange ask price. This may result from the fact that market makers may not be sufficiently interested in quoting such an option as it rarely traded, and/or it may not be worth to track its price. Thus, the market traders may not invest the time and resources necessary to determine a more accurate ask price for this option.

The term “relatively far” in this context, may relate to a difference between a strike price of an option and a spot price of a corresponding underlying asset. This distance may be measured, for example, based on the Delta of the option. For example, the distance between a spot price and a strike price which is above the spot price, may be measured based on the Delta of a call option corresponding to the strike price. The distance between a spot price and a strike price which is below the spot price, may be measured based on the Delta of a put option corresponding to the strike price. Deltas having absolute values of, for example, below 10% may indicate that options having a strike price corresponding to such Delta values may have low liquidity.

An accuracy level of a price of an option may be measured, for example, in terms of basis points, wherein a basis point represents a percent, e.g., 0.01%, of a notional of the option, i.e. the amount of the underlying asset that the option gives the right to buy or sell at the strike price. A buyer and a seller may typically negotiate buying/selling an option in terms of basis points. The smallest step-unit for such negotiation, may be, for example, half or quarter of a basis point. In the OTC market the bid-ask spread of options with a strike near the ATM strike may usually be, for example, a few basis points. In one year currency options of US Dollar versus Yen, the spread may be, for example, 4-5 basis points. In 5×5 swap options on Euro interest rates the spread may be, for example, 6 basis points. In one year copper ATM options the spread may be, for example, 20 basis points. According to some demonstrative embodiments of the invention, the accuracy of a price of an exchange traded option may be measured, for example, in relation to a typical ATM bid/ask spread, which may be determined, for example, according to the OTC market, or based on historical prices of the option in the exchange. A calculated mid-market price of an option may be defined as accurate, for example, if a difference between a calculated mid market price of the option and the middle between the market bid and ask prices (e.g., as received from OTC brokers and/or in the exchanges) is less than 10% of the typical ATM spread, or within a predefined range, e.g., 10% of the corresponding typical bid/ask spread of the option in the OTC market. Similarly, a calculated bid-ask spread of the option may be accurate if the calculated bid-ask spread is within a predefined range, e.g. 15%, of the market bid-ask spread of the option. The calculated mid-market price of the option may be defined as in-accurate, for example, if a difference between the calculated mid-market price of the option and the middle of the market bid and ask prices is within a predefined range, e.g., between 20%-50%, of the bid-ask spread of the option. The price of the option may be defined as extremely in-accurate, for example, if a difference between the calculated mid-market price of the option and the middle of the market price is larger than a predefined difference, e.g., 100% of the bid-ask spread, which may generate an arbitrage opportunity.

As indicated at block 207, according to demonstrative embodiments of the invention, the method may include determining a weight for one or more of the strike prices, e.g., based on an expected degree of accuracy of the exchange prices corresponding to the strike prices. For example, a plurality of weights, denoted W_{q}, corresponding to the plurality of strike prices K_{q}, respectively, may be determined as follows:

W_{q}=delta(Call(K_{q})) if K_{q}≧S (9)

W_{q}=abs(delta(Put(K_{q}))) if K_{q}<S

Accordingly, determining the one or more market volatility parameters may include reducing, e.g., minimizing, a weighted combination of the price differences, X_{q}. The weighted combination may include, for example, a weighted sum of the squares of the price differences or a sum of the absolute values of the price differences, e.g., as described below.

According to some demonstrative embodiments of the invention, determining the one or more market volatility parameters may include determining a set of volatility parameters corresponding to the expiration date, Tⱼ, e.g., the parameters ATM(Tⱼ), 25delta RR (Tⱼ), and/or 25delta butterfly (Tⱼ), according to the following condition:

$$A T M ( {T}_{j} ) , 25 delta RR ( {T}_{j} ) , \\ 25 delta butterfly ( {T}_{j} ) \text{:} {\sum }_{q = 1}^{l} {X}_{q}^{2} * {W}_{q} is minimal \qquad ( 10 )$$

Any suitable numerical analysis method may be implemented for determining the parameters ATM(Tⱼ), 25delta RR (Tⱼ), and/or 25delta butterfly (Tⱼ) in accordance with Condition 10. For example, the Newton-Raphson iterative method may be implemented with the constraint that 25delta butterfly is greater than zero, and with the following initial (e.g., speculative) values for ATM(Tⱼ), 25delta RR (Tⱼ), and 25delta butterfly (Tⱼ), denoted ATM0, 25RR0, and 25Fly0, respectively:

ATM0=0.5*(BSImVol(Kₐ)+BSImVol(K_{b})) (11)

25Fly0=0.2

25RR0=(BSImVol(K′_{25CALL})−BSImVol(K′_{25PUT}))

wherein K′_{25CALL} denotes an exchange strike that is closest to a strike k_{c}; K′_{25PUT} denotes an exchange strike that is closest to a strike kₚ; BSImVol (Kₐ), BSImVol (K_{b}), BSImVol (K′25CALL), and BSImVol (K′_{25PUT}) denote the Implied Volatility, according to the Black-Scholes model, for the strike prices Kₐ, K_{b}, K′_{25CALL} , and K′_{25PUT}, respectively; and wherein K_{C} and/or K_{P} may be determined, for example, based on the following equations:

delta Call (strike=K(_{c}, volatility=ATM0)=25%, (12)

delta Put (strike=Kₚ, Volatility=ATM0)=−25% (13)

As indicated at block 202, the series of operations described above with reference to blocks 204 and 206 may be performed repeatedly, e.g. m times, corresponding to j=1 . . . m. Some demonstrative embodiments of the invention as described herein relate to repeatedly performing the operations described with reference to blocks 204 and 206 m times, e.g., in order to determine one or more market volatility parameters corresponding to each one of the m expiration dates Tⱼ. However, it will be appreciated by those skilled in the art that, according to other embodiments of the invention, the operations described with reference to blocks 204 and/or 206 may be performed repeatedly any other desired number of times, e.g., less than m times, for example, in order to determine the market volatility parameters corresponding to only some of the expiration dates T.

According to some demonstrative embodiments of the invention, one or more operations of the numerical-analysis method, which may be used for determining one or more of the parameters, may be performed, e.g., iteratively, until a predetermined accuracy criterion is met. For example, the numerical-analysis method may be performed until the estimated volatility parameters enable determining the desired option prices with an accuracy level, e.g., of one basis point, or an accuracy of, e.g., 5% of the bid-ask spread assigned to the ATM. Alternatively, the numerical a-analysis method may be performed, for example, until a difference between the values of the weighted combination of the pricing values relating to two consecutive iterations is negligible.

As described above with reference to block 108 (FIG. 1), according to some demonstrative embodiments of the invention one or more estimated data parameters, e.g., volatility parameters, corresponding to the expiration date of the defined option may be determined based on one or more of the market volatility parameters corresponding to one or more of the expiration dates Tⱼ, e.g., as further described in detail below.

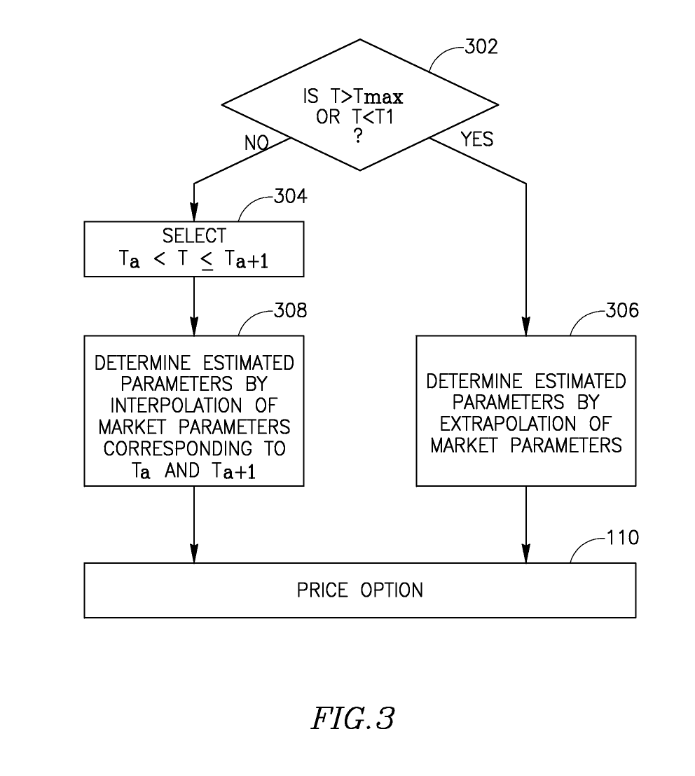

Reference is made to FIG. 3, which schematically illustrates a method of determining one or more estimated data parameters based on one or more market data parameters according to some demonstrative embodiments of the invention.

As indicated at block 302, the method may include determining whether to calculate the one or more estimated data parameters based on an interpolation or an extrapolation of two or more values of the market data parameters. For example, the method may include determining whether or not the expiration date T of the defined option is farther than a farthest known expiration date, Tₘₐₓ, e.g., wherein Tₘₐₓ may be defined as the farthest expiration date of dates T ⱼ in the exchange. The method may also include determining whether the expiration date T of the defined option is prior to the earliest expiration date, T₁.

As indicated at block 306, the method may include determining one or more of the estimated data parameters based on an extrapolation of two or more values of the market data parameters, e.g., if T>Tₘₐₓ or T<T₁. For example, ATM(T) may be determined based on an extrapolation between ATM values corresponding to two or more expiration dates Tⱼ, e.g., ATM(Tₘₐₓ) and ATM(Tₘₐₓ₋₁); 25delta RR(T) may be determined based on an extrapolation between 25delta RR values corresponding to two or more expiration dates e.g., 25delta RR(Tₘₐₓ) and 25delta RR(Tₘₐₓ₋₁); 25delta butterfly(T) may be determined based on an extrapolation between 25delta butterfly values corresponding to two or more expiration dates Tⱼ, e.g., 25delta butterfly(Tₘₐₓ) and 25delta butterfly(Tₘₐₓ₋₁); C(T) may be determined based on an extrapolation between cost of carry values corresponding to two or more expiration dates Tⱼ, e.g., C(Tₘₐₓ) and C(Tₘₐₓ₋₁); and/or D(T) may be determined based on an extrapolation between dividend rate values corresponding to two or more expiration dates Tⱼ, e.g., D(Tₘₐₓ) and D(Tₘₐₓ₋₁). Additionally, the value of ATMspread(T) may be determined based on an extrapolation between ATMspread(Tₘₐₓ), ATMspread(Tₘₐₓ₋₁) and/or any other ATMspread value. Similarly, if T<T₁, then ATM(T), 25delta RR(T), 25delta butterfly(T), C(T), and/or D(T) may be determined based on extrapolations of values corresponding to two or more expiration dates Tⱼ, e.g., T₁ and T₂.

As indicated at block 304, the method may include selecting from the j expiration dates two consecutive expiration dates, denoted Tₐ and Tₐ₊₁, such that Tₐ<T≦Tₐ₊₁, e.g., if T<Tₘₐₓ and T₁<T.

As indicated at block 308, the method may also include determining one or more of the estimated data parameters based on an interpolation of values of the market data parameters corresponding to the expiration dates Tₐ and Tₐ₊₁. For example, ATM(T) may be determined based on an interpolation between ATM(Tₐ) and ATM(Tₐ₊₁); 25delta RR(T) may be determined based on an interpolation between 25delta RR(Tₐ) and 25delta RR(Tₐ₊₁); 25delta butterfly(T) may be determined based on an interpolation between 25delta butterfly(Tₐ) and 25delta butterfly(Tₐ₊₁); C(T) may be determined based on an interpolation between C(Tₐ) and C(Tₐ₊₁); and/or D(T) may be determined based on an interpolation between D(Tₐ) and D(Tₐ₊₁). Additionally, the value of ATMspread(T) may be determined based on an interpolation between ATMspread(Tₐ) and ATMspread(T₊₁).

The extrapolation and/or interpolation may include any suitable extrapolation and/or interpolation method, e.g., a linear extrapolation/interpolation, a geometrical extrapolation/interpolation, a qubic-spline method, and/or any other extrapolation and/or interpolation as are known in the art. Any other desired interpolation or extrapolation method may be used. For example, the volatility parameters may be interpolated/extrapolated using any suitable weights, which may take into account holidays/weekends, since the volatility during holidays/weekends may usually be lower than the volatility during business days. Accordingly, it may be desired to use for holidays and/or weekends weights which are lower compared to the weights used for business days. This may enable achieving a higher accuracy level, e.g., for options having a short expiration period, e.g., of up to six months.

According to some demonstrative embodiments of the invention, any other suitable criteria may be used for estimating one or more parameters of the pricing model. The criteria may include, for example, a consistency of one or more of the estimated parameter values with respect to the expiration dates. For example, the method may include determining 25delta RR(T), 25delta butterfly(T), and/or the ATM(T) such that 25delta RR(T), 25delta butterfly(T), and/or ATM(T) are monotonous, e.g., with respect to the expiration dates. This may be achieved, for example, by using one or more constraints relating to “global” term structure consistency, e.g., in addition to the constraint of Equation 10. In another example, data may be available corresponding to only one expiration date. In this example, the available data may be used for approximating an option price corresponding to a desired expiration time based on any suitable mathematical assumption regarding the behavior of the volatility parameters and/or the dividend/carry parameters with respect to the expiration time. For example, it may be assumed that the rates change linearly over time with a certain slope, which may be constant, or may change as a function of time, e.g., as a square root of time. Any other desired assumption may be used, additionally or alternatively.

As described above with reference to block 110 (FIG. 1), according to some demonstrative embodiments of the invention the defined option may be priced based on the estimated volatility parameters ATM(T), 25delta RR(T), 25delta butterfly(T); the estimated carry cost C(T) and/or the estimated dividend rate D(T); and/or the estimated bid/ask spread ATMspread(T), for example, using a pricing method and/or system, e.g., as described in reference 1.

Following are examples for determining the forward rates, the weights W_{q}, and/or the volatility parameters ATM, 25delta RR, and 25delta butterfly, using the method for pricing options as described herein in accordance with some demonstrative embodiments of the invention. It should be noted that the trade information used in these examples have been randomly selected from market for demonstrative purposes only and is not intended to limit the scope of the invention to any particular choice of the trade information.

The following examples relate to options on the stock of Intel Corp. (stock symbol: INTL). Trade data related to these options was taken on Jul. 3, 2003 at around 12:30 pm EST. At this time, the stock traded at a mid price of 21.85. The data was taken for options corresponding to the expiration dates Aug. 3, 2004; Oct. 3, 2003; and Jan. 4, 2004, respectively. For each of the expiration dates, all the strikes that are close to the spot price which were liquid enough were taken into account.

TABLE 1
INTL, Expiration date Aug. 3, 2003

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| Put | 17.5 | 0.05 | 0.2 | 0.125 | 0.073588 | 0.115336 |
| Put | 20 | 0.45 | 0.5 | 0.475 | 0.241585 | 0.478396 |
| Call | 22.5 | 0.8 | 0.9 | 0.85 | 0.43769 | 0.848802 |
| Call | 25 | 0.15 | 0.2 | 0.175 | 0.140379 | 0.176626 |

TABLE 2
INTL, Expiration date Oct. 3, 2003

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| Put | 12.5 | 0.05 | 0.15 | 0.1 | 0.03144 | 0.080316 |
| Put | 15 | 0.15 | 0.3 | 0.225 | 0.071908 | 0.209736 |
| Put | 17.5 | 0.45 | 0.55 | 0.5 | 0.155126 | 0.49663 |
| Put | 20 | 1 | 1.15 | 1.075 | 0.304395 | 1.080167 |
| Call | 22.5 | 1.45 | 1.6 | 1.525 | 0.486365 | 1.526819 |
| Call | 25 | 0.6 | 0.75 | 0.675 | 0.279935 | 0.663844 |
| Call | 27.5 | 0.2 | 0.3 | 0.25 | 0.13098 | 0.264533 |
| Call | 30 | 0.05 | 0.15 | 0.1 | 0.059691 | 0.110163 |

TABLE 3
INTL, Expiration date Jan. 4, 2004

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| Put | 10 | 0.05 | 0.1 | 0.075 | 0.019198 | 0.060218 |
| Put | 12.5 | 0.1 | 0.25 | 0.175 | 0.045251 | 0.1703 |
| Put | 15 | 0.35 | 0.45 | 0.4 | 0.098907 | 0.400881 |
| Put | 17.5 | 0.8 | 0.85 | 0.825 | 0.190102 | 0.839624 |
| Put | 20 | 1.55 | 1.65 | 1.6 | 0.324903 | 1.588444 |
| Call | 22.5 | 2.05 | 2.2 | 2.125 | 0.514181 | 2.124372 |
| Call | 25 | 1.1 | 1.25 | 1.175 | 0.351105 | 1.18541 |
| Call | 27.5 | 0.6 | 0.65 | 0.625 | 0.220204 | 0.613562 |
| Call | 30 | 0.25 | 0.35 | 0.3 | 0.124091 | 0.302745 |

In each of Tables 1, 2, and 3, the first column includes the type of the options (Put/call); the second column includes the strike price of the options; the third column includes the bid price of the options, as received from the exchange; the fourth column includes the ask price of the options, as received from the exchange; and the fifth column includes a mid price of the options determined as an average of the prices of the third and fourth rows.

In each of Tables 1, 2, and 3, the sixth column includes the weights W_{q} assigned to the options according to demonstrative embodiments of the invention, e.g., using Equation 9 as described above.

The forward rates corresponding to the three expiration dates may be determined, e.g., using Equations 5, 6 and/or 7 as described above. The volatility parameters ATM, 25delta RR, and 25delta fly, corresponding to each one of the three options of Tables 1, 2, and 3 may be determined, e.g., separately, using the method described above with reference to FIG. 2. For example, the volatility parameters may be determined using the pricing model of Reference 1, based on the trade information of columns 1-5, the determined forward rates, and/or the assigned weights of column 6, e.g., such that the difference between the option prices determined by the pricing model using the volatility parameters and the exchange prices is reduced, e.g., minimized. For example, the following forward rates, and the volatility parameters may be determined for each of the three expiration dates, respectively:

TABLE 4

| | ATM volatility | 25delta RR | 25delta fly | Forward |
|---|---|---|---|---|
| Expiration date | (%) | (%) | (%) | rate |
| Aug. 4, 2003 | 38.62 | −6.21 | 0.23 | 21.869 |
| Oct. 3, 2003 | 39.64 | −8.85 | 0.86 | 21.888 |
| Jan. 4, 2004 | 38.57 | −7.82 | 0.50 | 21.888 |

The mid price of each of the options may then be determined, e.g., based on the determined volatility parameters. For example, column 7 of Tables 1, 2, and 3 includes the mid price of the options as determined by the pricing model using the pricing model of Reference 1, and the volatility parameter values of Table 4.

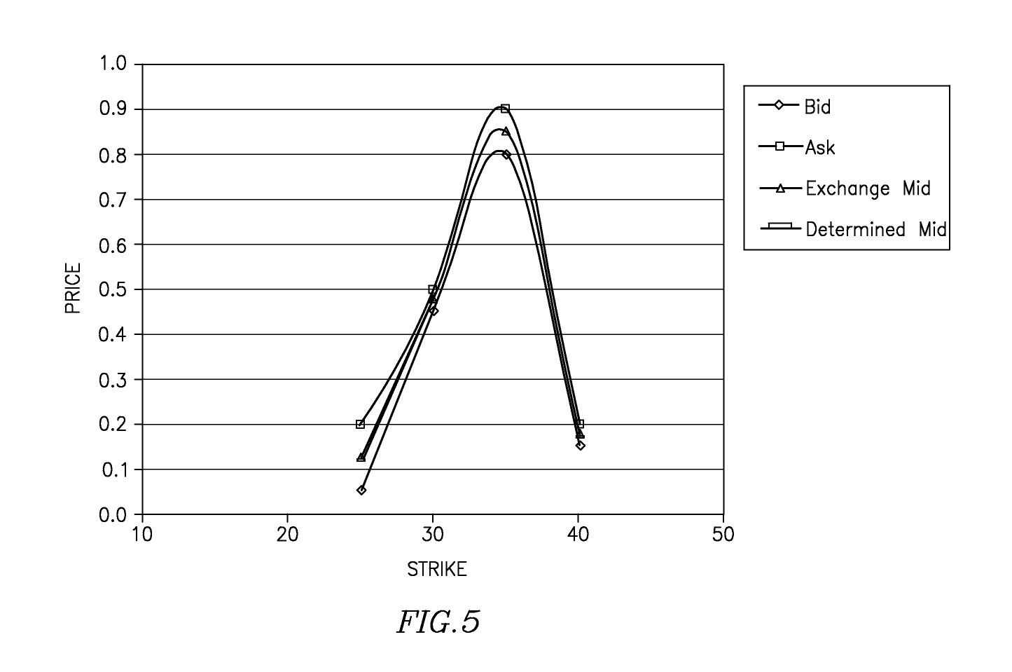

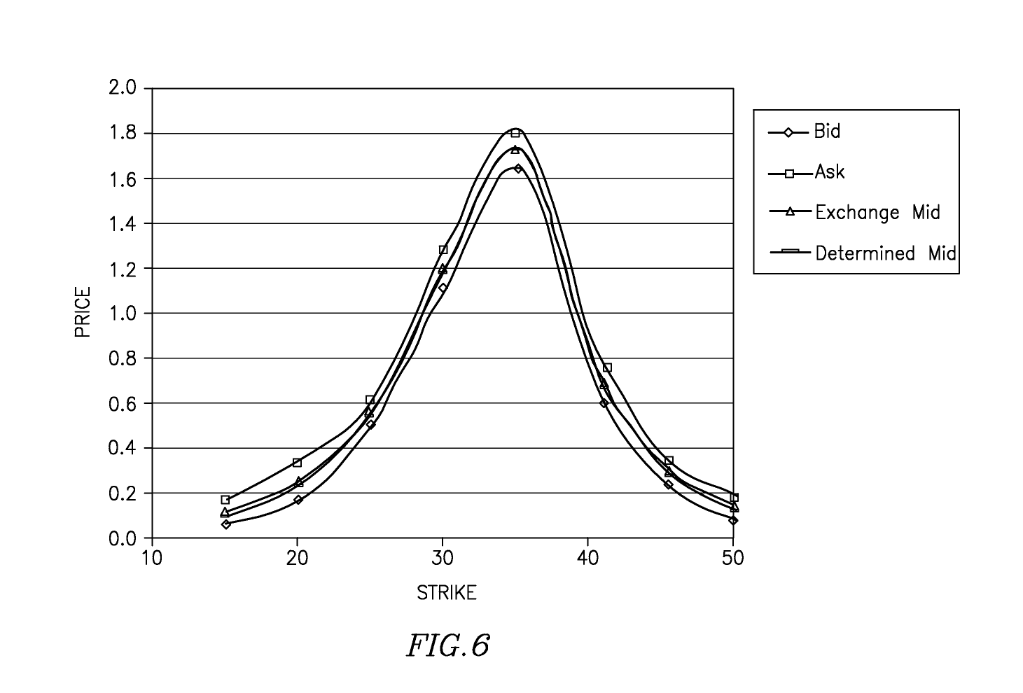

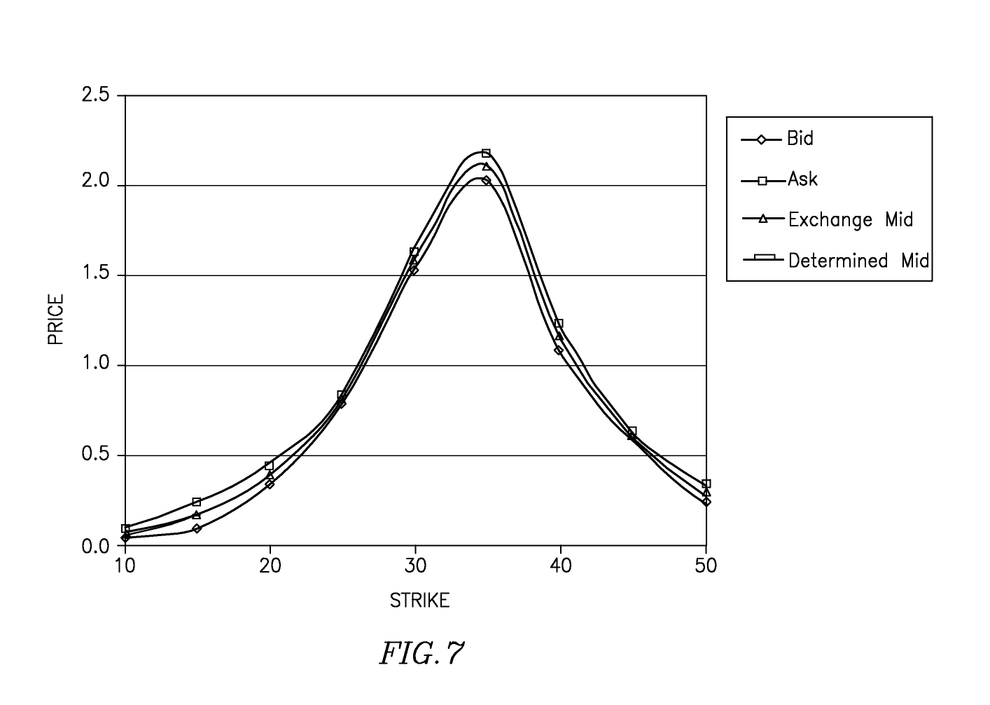

It will be appreciated that in each one of tables 1, 2, and 3, the differences between the exchange mid prices (column 5) and the mid prices determined using the pricing method according to embodiments of the invention (column 7) are generally negligible, as illustrated in FIGS. 5-7.

The pricing model of Reference 1 may then be used with the volatility parameters of table 4 , for example, in order to determine the price of any desired option corresponding to the Intel stock, e.g., as described above with reference to FIG. 1.

The following examples relate to options on the stock of Citigroup Inc. (stock symbol: C). Trade data related to these options was taken on Jul. 3, 2003 at around 7:30 pm EST. At this time, the stock traded at a mid price of 44.02. The data was taken for options corresponding to the expiration dates Aug. 3, 2004; Sep. 3, 2003; and Dec. 3, 2004, respectively. For each of the expiration dates, all the strikes that are close to the spot price which were liquid enough were taken into account.

TABLE 5
Citigroup, Expiration date Aug. 3, 2003

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| p | 37.5 | 0.1 | 0.2 | 0.15 | 0.067513 | 0.174904 |
| p | 40 | 0.35 | 0.5 | 0.425 | 0.167814 | 0.411348 |
| p | 42.5 | 0.9 | 1 | 0.95 | 0.339992 | 0.95539 |
| c | 45 | 0.95 | 1.1 | 1.025 | 0.405089 | 1.020691 |
| c | 47.5 | 0.25 | 0.4 | 0.325 | 0.176722 | 0.335815 |
| c | 50 | 0.05 | 0.2 | 0.125 | 0.075303 | 0.104251 |

TABLE 6
Citigroup, Expiration date Sep. 3, 2003

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| p | 32.5 | 0.1 | 0.15 | 0.125 | 0.037388 | 0.10217 |
| p | 35 | 0.2 | 0.25 | 0.225 | 0.067735 | 0.218433 |
| p | 37.5 | 0.35 | 0.5 | 0.425 | 0.124413 | 0.429978 |
| p | 40 | 0.75 | 0.9 | 0.825 | 0.223731 | 0.816667 |
| p | 42.5 | 1.4 | 1.55 | 1.475 | 0.369479 | 1.489944 |
| c | 45 | 1.45 | 1.65 | 1.55 | 0.440578 | 1.539742 |
| c | 47.5 | 0.55 | 0.7 | 0.625 | 0.243221 | 0.626224 |
| c | 50 | 0.1 | 0.25 | 0.175 | 0.093678 | 0.187242 |

TABLE 7
Citigroup, Expiration date Dec. 3, 2003

| | | Bid | Ask | Mid | | |
|---|---|---|---|---|---|---|
| | | (Ex- | (Ex- | (Ex- | | Mid |
| Type | Strike | change) | change) | change) | Weight | (Calculated) |
| p | 27.5 | 0.05 | 0.2 | 0.125 | 0.026375 | 0.151674 |
| p | 30 | 0.2 | 0.3 | 0.25 | 0.04961 | 0.265096 |
| p | 32.5 | 0.35 | 0.5 | 0.425 | 0.081826 | 0.434625 |
| p | 35 | 0.6 | 0.75 | 0.675 | 0.127194 | 0.691375 |
| p | 37.5 | 1 | 1.15 | 1.075 | 0.193629 | 1.07983 |
| p | 40 | 1.6 | 1.75 | 1.675 | 0.283273 | 1.645958 |
| p | 42.5 | 2.4 | 2.55 | 2.475 | 0.394355 | 2.471189 |
| c | 45 | 2.4 | 2.55 | 2.475 | 0.474866 | 2.497405 |
| c | 47.5 | 1.45 | 1.5 | 1.475 | 0.340937 | 1.455931 |
| c | 50 | 0.7 | 0.8 | 0.75 | 0.214248 | 0.757702 |
| c | 55 | 0.1 | 0.25 | 0.175 | 0.06685 | 0.16959 |

In each of Tables 5, 6, and 7, the first column includes the type of the options (Put/call); the second column includes the strike price of the options; the third column includes the bid price of the options, as received from the exchange; the fourth column includes the ask price of the options, as received from the exchange; and the fifth column includes a mid price of the options determined as an average of the prices of the third and fourth rows.

In each of Tables 5, 6, and 7, the sixth column includes the weights W_{q} assigned to the options according to demonstrative embodiments of the invention, e.g., using Equation 9 as described above.

The forward rates corresponding to the three expiration dates may be determined, e.g., using Equations 5, 6 and/or 7 as described above. The volatility parameters ATM, 25delta RR, and 25delta fly, corresponding to each one of the three options of Tables 5, 6, and 7 may be determined, e.g., separately, using the method described above with reference to FIG. 2. For example, the volatility parameters may be determined using the pricing model of Reference 1, based on the trade information of columns 1-5 of Tables 5, 6, and 7, the determined forward rates, and/or the assigned weights of column 6 of Tables 5, 6, and 7, e.g., such that the difference between the option prices determined by the pricing model using the volatility parameters and the exchange prices is reduced, e.g., minimized. For example, the following forward rates, and the volatility parameters may be determined for each of the three expiration dates, respectively:

TABLE 8

| | ATM volatility | 25delta RR | 25delta fly | Forward |
|---|---|---|---|---|
| Expiration date | (%) | (%) | (%) | rate |
| Aug. 4, 2003 | 25.26 | −4.58 | 0.68 | 43.93332 |
| Sep. 3, 2003 | 25.73 | −6.55 | 0.15 | 43.925 |
| Dec. 3, 2003 | 26.03 | −7.35 | 0.28 | 43.84172 |

The mid price of each of the options may then be determined, e.g., based on the determined volatility parameters. For example, column 7 of Tables 5, 6 and 7 includes the mid price of the options as determined by the pricing model using the pricing model of Reference 1, and the volatility parameter values of Table 8.

It will be appreciated that in each one of tables 5, 6 and 7, the differences between the exchange mid prices (column 5) and the mid prices determined using the pricing method according to embodiments of the invention (column 7) are generally negligible.

The pricing model of Reference 1 may then be used with the volatility parameters of table 8 , for example, in order to determine the price of any desired option corresponding to the Citigroup stock, e.g., as described above with reference to FIG. 1.

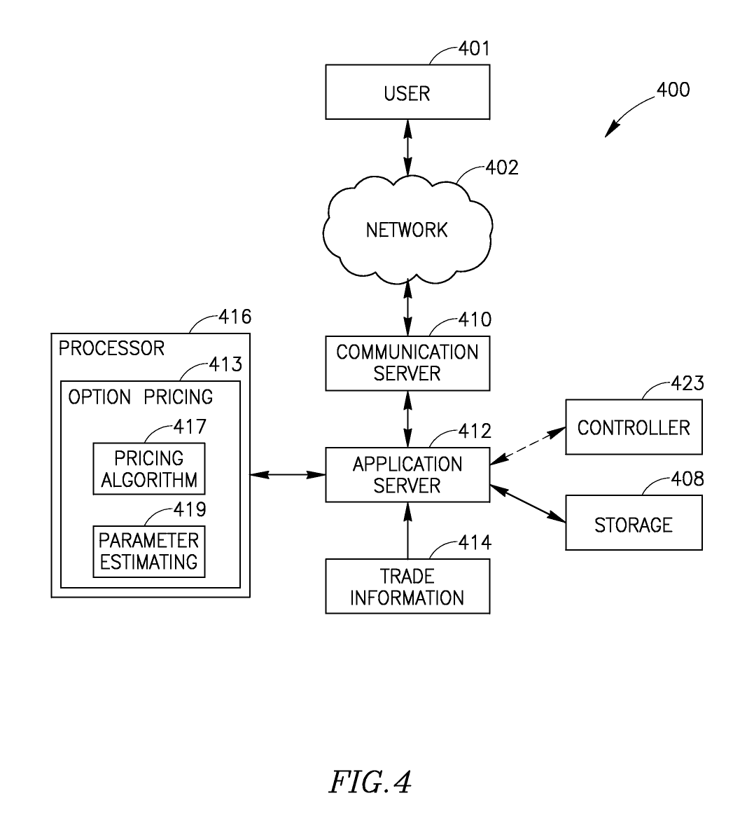

Reference is now made to FIG. 4, which schematically illustrates a system 400 of pricing financial instruments, e.g., financial derivatives, in accordance with some demonstrative embodiments of the invention.

System 400 may include an application server 412 to process user information, e.g., including details of a defined option to be priced, received from a user 401, as well as trade information 414, e.g., real time trade information, received, for example, from one or more sources, as described above with reference to block 102 (FIG. 1). System 400 may also include a storage 418, e.g., a database, for storing the user information and/or the trade information.

Application server 412 may include any suitable combination of hardware and/or software known in the art for processing and/or handling the user information and/or the trade information.

Application server 412 may be associated with a controller 423, as is known in the art, able to control and synchronize the operation of different parts of system 400.

Application server 412 may be associated with a pricing processor 416 able to execute one or more instructions resulting in an option pricing module 413 for pricing a defined option, e.g. based on a suitable pricing model as described above with reference to FIGS. 1, 2 and/or 3. For example, module 413 may include a pricing algorithm 417 for pricing financial derivatives, e.g., as described in Reference 1. Module 413 may also include a parameter estimating algorithm 419, for determining one or more market volatility parameters corresponding to one or more predetermined expiration dates, as described above with reference to FIGS. 2 and/or 3.

The user information may be received from user 401, for example, via a communication network 402, e.g., the Internet or any other desired communication network. For example, system 400 may include a communication server 410, as is known in the art, which may be adapted to communicate with network 402, via a communication modem, as is known in the art. According to some demonstrative embodiments of the invention, user 401 may communicate with communication server 410 via network 402 using a personal computer, or any other suitable user interface, e.g., having a communication modem for establishing connection with network 402, as is known in the art. According to other embodiments of the invention, user 401 may communicate with network 402 directly, for example, using a direct telephone connection or a Secure Socket Layer (SSL) connection, as are known in the art. In another embodiment of the invention, user 401 may be connected directly to application server 412, for example, via a Local Area Network (LAN), or via any other communication network known in the art.

Trade information 414 may be received, for example, directly by application server 412 using any direct connection means as are known in the art. Alternatively, trade information 414 may be received from sources available on network 402, e.g., using communication server 410.

Application server 412 may communicate a determined bid price and/or offer price, e.g., determined by module 413, corresponding to the defined option to user 401 via communication server 410, e.g., in a format convenient for presentation to user 401.

A system, e.g., system 400, for pricing financial derivatives according to some embodiments of the invention, may provide price information, e.g., bid and ask prices, expiration date, barrier, strike price, and/or any other desired information, for a plurality of options, e.g., including any desired type of option. This may be achieved using a relatively small number of input parameters, e.g., three volatility parameters corresponding to one or more “benchmark” dates, as described above. The input parameters may be easily obtained, e.g., by pricing module 413, on a real time basis. Thus, pricing module 413 may provide user 401 with a plurality of real time estimated prices of any desired plurality of strike prices, e.g., based on real time prices received from the exchanges and/or OTC market. Pricing module 413 may update, e.g., substantially immediately and/or automatically, one or more of the estimated prices, for example, in response to a change in spot prices and/or option prices. This may enable user 401 to automatically update bid and/or offer prices for trading with the exchanges. Additionally, if one or more of the volatility parameters change, the prices of one or more options corresponding to any required strike prices may be updated by updating a relatively small number of parameters. For example, it may be required to update only three volatility parameters for a given expiration date, e.g., if the modeling price of Reference 1 is used. Accordingly, option prices may be obtained, for example, for six or seven expiration dates, for which data has been updated. Thus, a market maker may relatively easily support options of a large range of strikes and expiration dates. Alternatively, a hedge fund may buy a large amount of options by buying several strikes simultaneously, while handling many strikes and expirations simultaneously.

A trader may want, for example, to submit a plurality of bid prices for a plurality of options, e.g., ten bid prices for ten options, respectively. When entering the bids to a quoting system, the trader may check the price, e.g., in relation to the current spot prices, and may then submit the bids to the exchange. Some time later, e.g., a second later, the spot price of the stock which is the underlying asset of one or more of the options may change. A change in the spot prices may be accompanied, for example, by changes in the volatility parameters, or may include just a small spot change while the volatility parameters have not changed. In response to the change in the spot price, the trader may want to update one or more of the submitted bid prices. The desire to update the bid prices may occur, e.g., frequently, during trade time.

A pricing system according to some demonstrative embodiments of the invention, e.g., system 400, may automatically update the bid prices entered by the trader, e.g., based on any desired criteria. For example, pricing module 413 may evaluate the trader's bids versus bid and offer prices of the options, which may be estimated according to the pricing model of algorithm 417, e.g., when the trader submits the bid prices. Pricing module 413 may then automatically recalculate the bid and offer prices, e.g., whenever the spot changes, and may automatically update the trader's bid prices. Pricing module 413 may, for example, update one or more of the trader's bid prices such that a price difference between the bid price calculated by pricing model of algorithm 417 and the trader's bid price is kept substantially constant. According to another example, pricing module 413 may update one or more of the trader's bid prices based on a difference between the trader's bid prices and an average of bid and offer prices calculated by pricing model of algorithm 417. Pricing module 413 may update one or more of the trader's bid prices based on any other desired criteria.

It is noted, that a change of the spot price, e.g., of a few pips, may result in a change in one or more of the volatility parameters of options corresponding to the spot price. It will be appreciated by those skilled in the art, the a pricing module according to some embodiments of the invention, e.g., pricing module 413, may enable automatically updating one or more option prices submitted by a trader, e.g., while taking into account the change in the spot price, in one or more of the volatility parameters, and/or in any other desired parameters, as described above. According to some demonstrative embodiments, pricing module 413 may enable the trader to manually update any desired parameter, e.g., one or more of the volatility parameters and/or the dividend rates, and pricing module 413 may accordingly update the submitted prices, e.g., immediately. Alternatively, a trader may submit one or more quotes in the exchange in a form of relative prices vs. prices determined by the pricing model of algorithm 417. For example, the trader may submit quotes for one or more desired strikes and/or expiry dates. The quotes submitted by the trader may be in any desired form, e.g., relating to one or more corresponding prices determined by the pricing model. For example, the quotes submitted by the trader may be in the terms of the bid price determined by the pricing model plus two basis points; or in the terms of the mid market price determined by the pricing model minus four basis points, etc. Module 413 may use algorithm 417 for determining the desired prices, for example, in real time, e.g., whenever a price change in the exchange is recorded. Alternatively, pricing module 413 may use algorithm 417 for determining the desired prices, according to any other desired timing scheme, for example, every predefined time interval, e.g., every half a second.

A change in a spot price of a stock may result in changes in the prices of a large number of options related to the stock. For example there could be over 200 active options relating to a single stock and having different strikes and expiration dates. Accordingly, a massive band width may be required by traders for updating the exchange prices of the options in accordance with the spot price changes, e.g., in real time. This may lead the traders to submit to the exchange prices which may be “non-competitive”, e.g., prices including a “safety-margin”, since the traders may not be able to update the submitted prices according to the rate at which the spot prices, the volatility, the dividend, and/or the carry rate may change.

According to some demonstrative embodiments of the invention, pricing module 413 may be implemented, e.g., by the exchange or by traders, for example, to automatically update one or more bid and/or offer prices submitted by a trader, e.g., as described above. This may encourage the traders to submit with the exchange more aggressive bid and/or offer prices, since the traders may no longer need to add the “safety margin” their prices for protecting the traders against the frequent changes in the spot prices. Accordingly, the trading in the exchange may be more effective, resulting in a larger number of transactions. For example, a trader may provide system 400 with one or more desired volatility parameter and/or rates. The trader may request the system to automatically submit and/or update bid and/or offer prices on desired amounts of options, e.g., whenever there is a significant change in the spot price and/or in the volatility of the market. The trader may also update some or all of the volatility parameters. In addition, system 400 may be linked, for example, to an automatic decision making system, which may be able to decide when to buy and/or sell options using the option pricing model of Reference 1.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A method of pricing a financial instrument relating to an underlying asset, the method comprising:
receiving trade information of a plurality of traded financial instruments related to said underlying asset, said trade information including trade information related to a plurality of market prices corresponding to said plurality of traded financial instruments;
determining at least one set of market parameter values based on a predefined criterion that relates to a plurality of sets of one or more of said plurality of market prices and to a plurality of sets of one or more model prices that are calculated for said at least one set of market parameter values by a pricing model using said trade information; and
estimating a price of said financial instrument using said pricing model based on said at least one set of market parameter values.
